(19) United States
(12) Patent Application Publication
(10) Pub. No.: US 2004/0210483 A1
(43) Pub. Date: Oct. 21, 2004

(54) Method and apparatus for digitally integrating sales, confirmation and billing of published advertising

(76) Inventors: Thomas H. Watkins III, Orange, NJ (US); Linardo Thorne, Hackensack, NJ (US)

Correspondence Address: Richard C. Woodbridge, Esq., Synnestvedt Lechner & Woodbridge, LLP, P.O. Box 592, Princeton, NJ, 08542-0592, US

(21) Appl. No.: 10/827,406

(22) Filed: Apr. 19, 2004

Related U.S. Application Data
(60) Provisional application No. 60/464,406, filed on Apr. 18, 2003.

(51) Int. Cl. G06F 17/60; G06F 15/16

(52) U.S. Cl. 705/14

(57) ABSTRACT

An integrated electronic system enabling the transaction of advertising business related to printed publications over an electronic network, using standard web interfaces, including well known browsers. Advertisers my use the system to negotiate and purchase advertising space from a variety of printed publications and to upload digitized advertising copy. Publishers may securely accept and process the bids for advertising space, including keeping track of agreed upon run schedules, also using standard web interfaces and browsers. The system and apparatus also allows publishers to simply, securely, promptly and digitally produce bills that contain, or are linked to, acceptable proofs-of-publication. The acceptable proofs-of-publication may be digitized images of tearsheets placed on fiducial under-lays. The integrated system and apparatus also allows the advertiser to simply and promptly pay acceptable bills by using electronic payment systems incorporated into the web pages.

### CROSS REFERENCE TO RELATED APPLICATIONS

This application is related to, and claims priority from, U.S. Provisional Patent application No. 60/464,406 on April, 18th, 2003, by Thomas H. Watkins III and Linardo Thorne titled “Method and apparatus for digitally integrating sales, confirmation and billing of published advertising”, the contents of which are hereby incorporated by reference.

### FIELD OF THE INVENTION

The present invention relates to methods, apparatus and systems for digitally integrating the sales, confirmation and billing functions of published advertising, and particularly to web-based methods and systems that incorporate convincing digital proof of publication.

### BACKGROUND OF THE INVENTION

Publishers of periodicals and daily newspapers derive significant revenue from selling print advertisements in their publications. Traditionally, selling the advertising in such publications has been done by third party agencies know as “reps”. Agencies that provide advertising rep services typically take a significant fraction of the advertising revenue.

Once the advertising has been printed, the publisher needs to generate both a bill and a confirmation of that printing. This confirmation needs to satisfactorily prove to the purchaser details such as that the advertisement was printed in the publication on the correct date, in the required position and was produced to an agreed or acceptable standard or quality. Traditionally this is done by sending a tearsheet along with the bill. A tearsheet is an actual, physical copy of the page on which the advertising appeared, taken from a copy of the publication. It is usual to supply a tearsheet for each billing line item. Such a system requires physically mailing the tearsheet, which is both costly and time consuming.

Prior art attempts to digitize and integrate some of the actions related to publishing printed advertisements include U.S. Pat. No. 6,505,173 to Weibel, et al. entitled “Method for electronically merging digitized data system of generating billing statement for published advertising”, the contents of which are hereby incorporated by reference. The system described by Weibel et al. is limited to the integration of a bill with a reference to a digital tearsheet substitution. In the Weibel system, the tearsheet substitution may be generated either from the digital publishing system used to produce the advertising or by scanning the publication. A problem with sending the image generated from the publishing system is that there is no indication whether the advertisement was actually printed. A problem with scanning the publication is that, if there are defects of quality, it is not clear from the scanned image if these defects occurred in the printing process or in the subsequent scanning. Neither of these methods fully satisfies an advertiser's need to know that the advertisement was actually printed in the publication, was the right size and was produced to the desired level of quality.

What is needed is an integrated system that allows advertisers to negotiate and purchase advertising, and also allows publishers to simply, promptly and digitally produce bills that contain acceptable proofs of publication. A further requirement of such an integrated system is provision of a system that allows the advertiser to simply and promptly pay the bill, once they receive satisfactory proof of publication.

### SUMMARY OF THE INVENTION

The present invention relates to a web-site based, integrated electronic transaction system that allows the full range of activities associated with buying and selling advertising in printed publications to be accomplished electronically, online and preferably at a single website.

The invention allows a purchaser of advertising to use a website to submit a bid or an offer for having advertising published in one or more of a group of publications represented on that website. As part of that offer the purchaser may also upload a digital version of the advertisement they want published. Using the same website, the publishers can accept or decline the offer. When the publisher accepts the offer, the website automatically generates a run schedule, i.e., list of dates and details that remind the publisher of when and how to print the advertising. One the advertisement has been printed, the website also allows the publisher to upload a digital proof of publication and generate a bill for the purchaser. The purchaser may then use the website to review the bill and associated proof of publication. If satisfied, the purchaser may then pay the bill electronically using the website. In paying the bill, any commissions due to advertising agencies and rep firms are calculated and also automatically paid.

In a preferred embodiment, the integrated system of the present invention includes provision for the purchaser of advertising to select publications either directly by name or website code word, or by entering requirements such as, but not limited to, publication frequency, readership demographic, advertising types and classifications available. On entering their requirements, the purchaser may be presented with a list of suitable publications which match those requirements. Once the user selects their list of publications, an insertion request form may display the costs associated with selection, including totals, based on standard rates charged for the advertising schedule proposed. The purchaser may then amend their list or insertion requirements, including entering offered rates different from the standard rates. The offer from the purchaser, and any attached digital version of the advertisement, is then made available to the publisher who may accept, reject or negotiate further by making a counter-offer.

In the preferred embodiment, the digital proof of publication is in the form of a digital image of a traditional tearsheet, photographed on a fiducial underlay, which may include markings that allow the user to ascertain if the advertisement was produced to the required quality, which may include size, placing, resolution and color reproduction.

This and further advantages are explained in more detail blow with reference to the attached drawings.

### BRIEF DESCRIPTION OF THE DRAWINGS

FIG. 1 is a schematic overview showing an embodiment of the inventive concepts of the present invention.

FIG. 2 is a schematic flow chart showing one embodiment of the methods of the present invention as applicable to an advertiser.

FIG. 3 is a schematic flow chart showing one embodiment of the methods of the present invention as applicable to a publisher.

FIG. 4. is a plan view of an electronic proof of publication as generated in accordance with the inventive concepts of the present invention.

FIG. 5 is a schematic view of the generation and transmission of a proof of publication in accordance with the inventive concepts of the present invention.

FIG. 6 is a schematic view of a further method of generation and transmission of a proof of publication in accordance with the inventive concepts of the present invention

### DETAILED DESCRIPTION

The invention of this application relates to an integrated system that satisfies the needs of both publisher and advertiser. In particular, the preferred embodiment of the invention includes web-based methods and apparatus designed to eliminate the need for costly transfer fees by providing a direct, effective and streamlined process for purchasing advertising space in newspapers. In addition, the invention of this application provides apparatus and method for simply and efficiently producing a digitized proof of publication that fully satisfies the advertiser's need to know that the advertisement was published on the right day at the right size and was produced to the necessary level of quality.

In a preferred embodiment, the invention simplifies the extensive, often time-consuming, paperwork traditionally associated with ad placement without compromising the efficient and accurate communication that advertisers and newspapers rely on.

In a preferred embodiment, the functions integrated into a single website based, electronic business system include, but are not limited to, publication selection, advertising placement offer submission, provision for negotiation of offers, proof of publication, payment and reporting. All of these functions may be made available at a website via an Internet connection such as, but not limited to, a dial up line, a high speed cable connection, a high speed land line or a suitable wireless connection.

In a preferred embodiment, publication selection may be facilitated by means of an extensive query page on the web site. This query page allows the advertiser to define the type of publications the advertiser wishes to use by specifying search criteria including but not limited to, readership demographics, publication frequency, types of advertising accepted and space availability on required dates. The site may return a list of the publications that match the search criteria and displays them along with relevant related material including, but not limited to, the column inch rate of the publication and a link to the each publication's online press kit by clicking on an individual publication. Each online press kit includes information such as, but not limited to, demographic, geographic and rate sheet information plus a link to the publications web site for optional more detailed investigation.

In a preferred embodiment advertising placement is further facilitated by a web page that produces an offer from the potential advertiser to the publication that the advertiser wishes to advertise in. Once a publication has been selected, the advertiser may use the offer function to do the following:

1. Negotiate price. In the preferred embodiment this is facilitated by changing the column inch rate, which is shown along with the selected publication identifier. This allows the advertiser to submit bids with prices different from those on record as the standard price. The offer facility of the preferred embodiment helps the advertiser place a comprehensive bid that will meet their budget by keeping a running total of the cost of the buy based on the offered column inch rate.

2. Select run-dates using an automated calendar. By simply clicking on the dates the advertisement is required to appear in the selected publications, the dates selected will automatically be attached or associated to the appropriate insertion order.

3. Up-load digital advertisements. This may be done using the browser buttons to select previously stored advertising files for uploading. The stored digital advertisement will be automatically attached to the appropriate insertion order.

Once the necessary information has been entered and reviewed a single create offer button click will send each offer to each selected publication in the form of an insertion order. Each insertion order contains all information needed for placement, tracking and billing of the advertisement.

In a preferred embodiment the system also produces an automatic notification of offer by sending each publication an offer is made to, an appropriate e-mail notification. In the preferred embodiment, this e-mail informs them that an offer has been submitted and includes a reminder to sign-on to their account on the system in order to process the offer, including the opportunity to accept or reject your offer. In one embodiment of the system they also have the option to enter into negotiations regarding offers. In the event that the publication accepts the offer, a run-sheet is created for the paper to prevent the ad from being missed. The publication can also download the attached advertisement at this time.

In a preferred embodiment, the system also facilitates proof of publication. After the advertisement runs, i.e. the advertisement has been published, and the publisher up-loads the digital proof, in compliance with guides lines supplied by the web-site provider, the advertiser is notified via e-mail to go on-line and approve or reject the digital proof of publication. In a preferred embodiment, the publisher produces the digital proof of publication by placing a tearsheet on a graphic background board and taking a high quality digital photograph of the tearsheet on the background board. The resultant digital proof of publication shows everything a paper proof would in terms of the advertisement, as published, including its size, quality and position on page. The digital proof is provided on the website, appropriately linked to the original insertion order.

In a further embodiment of the system, payment from the advertiser to the publisher is facilitated by incorporating an electronic payment scheme such as, but not limited to, the well known PayPal system. This allows the advertiser, after all appropriate digital proofs of publication have been approved, to send or authorize payment simply and efficiently from the same website. In a preferred embodiment this payment is facilitated by a single click of an update button.

In a further embodiment, the system of this invention further facilitates advertising by generation of appropriate reports. These reports, which may be customized by the user making appropriate choices, allow the user to for instance, but not limited to, view the advertisements that ran and which periodicals they were published in along with the rates charged. Additional reports can be created. The system also generates reports for the publisher, including reports which allow the publisher to view which ads are scheduled to run in which of their publications.

In a preferred embodiment of the invention, all reports are available to be downloaded in standard formats such as, but not limited to Excel, PDF, Word or Text Files.

Advantages of the system of this invention for the advertiser include the fact that they are not forced to use a pre-packaged group of publications. The advertiser may research, and select the areas where they want the advertisement to run. They have the option to set the exact advertisement size and price they are prepared to pay for the advertisement.

Advantages of the system of this invention include the fact that once the approval process is completed, the system handles the rest of the publication details. A further advantage is that all proofs of publication (also known as digital tear sheets) are online. Once the advertiser is satisfied that the publication has completed their obligation, they may approve the invoice online. As soon as the invoice is approved, the check may be sent to the publication on the next business day. The advertiser needs to send only one check, or make one electronic payment, for the total cost of the advertising. The system handles payments to all parties involved in the transaction, including but not limited to publisher, agencies and reps, once the advertiser has verified the proof of publication.

Advantages for the publisher include the ability for them to securely enter their own publication data, circulation data and rates into the system. A further advantage to the advertiser is that the Advertisement Requests are sent through the system. The publisher has the option to accept, reject or negotiate the rate. The system helps facilitate actual publication by showing the publisher what advertisements are suppose to run on what dates. The publishers provide and load the proof that the ad ran themselves. The publisher only needs to view the invoice, the check is sent as soon as the advertiser approves the invoice.

The present invention will now be described by reference to the drawings in which like numbers represent like elements.

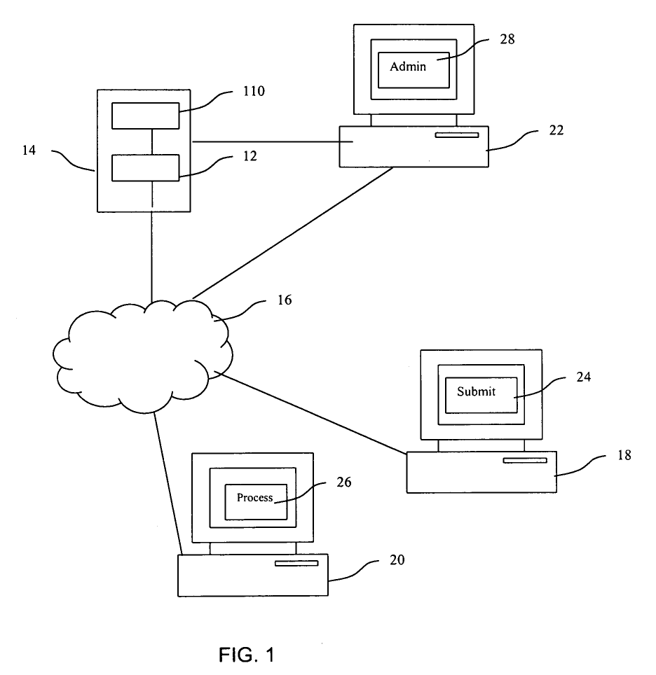

FIG. 1 is a schematic overview showing an embodiment of the inventive concepts of the present invention, including a website 10, a web server 12, a server 14, a network 16, a first user computer 18, a second user computer 20 and a third user computer 22. The website 10 is comprises well known electronically executable computer code, typically residing in a well known memory device on a server 14, which may be any suitable well known digital computer. A web-server 12 is a computer program residing on the server 14 and capable of communicating over a network 16. The web-server 12 mediates with the web-site 10, allowing interaction of elements and databases of the web-site with remote computers 18, 20 and 22 in forms such as, but not limited to, well known an active server page (ASP) pages, HTML pages, CGI scripts and other suitable network and computer constructs. Network 16 may be any suitable network such as, but not limited to the Internet or World Wide Web. Computers 18, 20 and 22 may be any suitable well known digital computers. Computer 18 represents a adverting user computer accessing the web-site 10 via an submission page 24. The submission page 24 is a graphical representation of HTML page code and may have functionality restricted to an advertising user of the system such as, but not limited to submitting an offer. Computer 20 represents a publisher accessing the web-site 10 via a processing page 26. Processing page 26 may be an HTML page having functionality restricted to publishing members such as, but not limited to, processing an offer. Computer 22 represents a provider of the service accessing the web-site either directly or via the network, using an administration page 28. Administration page 28 may be a well known HTML page allowing the provider to administer the website 10.

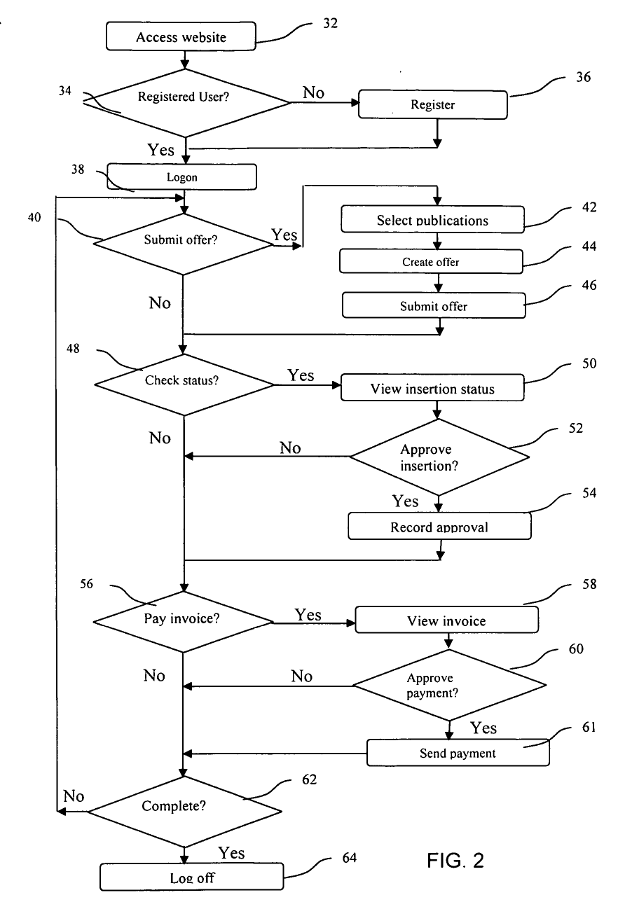

FIG. 2 is a schematic flow chart showing one embodiment of the methods of the present invention as applicable to an advertiser. In a preferred embodiment the system is implemented as a software package on a centrally located server. In a first step 32, an advertising user accesses the system via a web-browser over the Internet or other suitable information exchange network. At the next step 34 in the user/system interaction, the system queries the user as to whether they are previously registered users or not. If the user is not previously registered, they are invited to register in step 36 by filling in a form, which may be presented as, but not limited to, an active server page (ASP).

In a preferred embodiment, registration 36 includes, but is not limited to providing a 4-12 character ID, an e-mail address, a password and auxiliary identification information such as, but not limited to, a birth date. Important information such as, but not limited to, the password is typically asked for more than once to ensure accurate entry. The registration information may be e-mailed to a system administrator, where the information is processed, an appropriate account set up and the user informed of the outcome of their application and the steps necessary to access the required functions on the system.

Once the user is registered, they are able to proceed to Logon in step 38. In the log on procedure 38, of the preferred embodiment, the user is asked for their user ID, their password and a media code. The user ID and password authenticate the user while the media code ensures access to the appropriate functions. Media codes include, but are not limited to newspaper publishers, advertisers and system managers. As an advertiser, the user would need an appropriate advertiser media code.

In a preferred embodiment, an advertiser user is then presented with a web page having links that will allow them to perform a number of functions including, but not limited to, submitting an offer, check on the status of an offer or an insertion, or pay for services rendered.

If the user chooses to submit an offer in step 40, they will be presented with one or more submission pages. These submission pages will enable them to proceed to step 42, in which they will select one or more printed publications in which to place their print advertisements. The publication selection step 42 may include one or more publication selection pages with questions designed to find suitable printed publications from the systems database of publications. In a preferred embodiment, the information requested includes criteria such as, but is not limited to, advertising type, i.e., whether the advertising is black and white, 1 color, 2 color, 3 color or 4 color; a classification, out of a list such as but not limited to, Arts & Entertainment, Automotive, Business, Consumer, Display, Education, General Classified, Healthcare, Magazine, Media, Real Estate, Recruitment, Retail, Technology, Travel; what the publication format is, out of a list such as but not limited to, Broadsheet, Magazine, or Tabloid; the publication frequency, from a list such as but not limited to, Bi-weekly, daily, monthly, semi-weekly, weekly; the column width of the advertisement, the total column inches for the ad, the required run dates. The user may also be prompted for their requirements of the publication including, but not limited to, publication readership demographics, including but not limited to state or zip code of residence, median head of house income, age, education and work experience. The magazines may also be chosen by specialized interest requirement, chosen from a list such as, but not limited to circulation, minority ownership, readership gender or publication type including, but not limited to, college, ethnic, general, military, senior, agriculture, antiques, automobiles, aviation/aerospace, boats & yachting, business, cattle/livestock, Clubs, College/Alumni, Communications, Community, Court, Electronics, entertainment, farming, fishing & hunting, florist, gay & lesbian or sports, or some combination thereof.

Once the information is entered, the publication selection page may show a list of suitable publications and may include details of costs and other appropriate data such as any of the selection criteria. The advertising user may then select publications from this list of suitable publications.

The user may also select publications by name or system ID number and they may also use a view a publication option to show them the publications available of the system along with the appropriate details of the publications, including but not limited to, any of the categories listed above. The system may also have links to the web pages of the magazines themselves.

Once the advertiser has selected appropriate publications, they may proceed to step 44 of creating an offer. In this step they will be presented with one or more offer creation pages that may allow them create, generate or complete an insertion request form, thereby generating or creating an offer. The appropriate information gathered in the publication selection step 42 is now displayed along with costs, including standard rates charged by the publications. In step 44 of creating an offer, the advertiser may also negotiate by submitting bids (also known as “an offered amount”) in which an offered rate is proposed for the column inch rate, or other method of pricing the insertion, the offered rate being different from the standard rate presented in the publications media kit or by the system of this invention. In a preferred embodiment, the offer creation step will generate a page that shows total amounts based on the offered rate (also known as “bid rate) so that the advertiser is aware of the actual costs that will be incurred if the bid is successful. In the preferred embodiment, the advertiser will also include a digital form of each of the advertisements along with the bid. This may be done by uploading the appropriate advertisement file to the offer form or submission page. Once the advertiser has put together a satisfactory offer to the various publications, the advertiser may submit the offer in step 46 by pressing an appropriate button on the offer form page.

In the preferred embodiment, the step 46 of submitting the offer results in the offer details, including pricing bids (also known as “the offer amount”), run dates, advertising copy in digital form and other data necessary for the publication both to decide whether to accept the offer or not and to run in the insertion if they choose to accept, being placed in a file or position accessible by authorized entities of the selected publications. In the preferred embodiment, step 46 of submitting the offer also generates a notification of offer, in the form of an e-mail, instant message or other electronic communication, to the appropriate contact person or authorized entity at each of the selected publications informing them of the offer and prompting them to access the appropriate section of the system in order to further process the insertion request.

The advertising user may wish to check the status of an insertion request in step 48 by proceeding to the web page provided by the view insertion status link. In the step 50 of viewing insertion status, the advertising user may be presented with one or more status pages which are web page displaying all their past bids for a selected time period and the status of those bids. On these pages they are be able to see which bids where accepted or rejected, and of the accepted bids what their status is with respect to being run. Once the advertisements have been run, advertising user may also be able to access a digital proof of publication from these pages. In the preferred embodiment, this proof of publication may consist of a digital image of an actual printed page that contains the advertisement, taken from the publication on the required date and placed in position on a standard background containing fiduciary markings such as, but not limited to, a sized grid, company logos, numbers, letters or a combination thereof. This digital image may be taken with a digital camera of sufficient resolution such as but not limited to, a 2-3 Megapixel camera such as but not limited to the Fuji FinePix 3800, the Kodak EasyShare DX4330 or the Fuji Finepix F601Z models.

If the advertiser is satisfied that the advertisement has been satisfactorily run, then in step 52 the advertiser may approve the insertion on the web page. Approving the insertion may cause the system to record the approval in step 54 and also automatically generate an invoice for payment.

In one embodiment of the invention, if the advertiser is ready to pay, they may choose the pay invoice option in step 56 that may lead them to a suitably secure web page linked to a suitable electronic payment system. Such suitable electronic payment systems are well known and include, but are not limited to, the well-known PayPal system operated by eBay. In step 58, the advertising user isbe able to view the invoice. In step 60, the advertising user may approve payment. In step 61, the advertising user may to send the payment.

In the preferred embodiment, step 60 of the electronic payment system is used in such a way that all parties involved are automatically paid correctly. For instance, in many advertising transactions, it is customary for the advertising agency that produced the artwork used in the advertisement to receive a percentage of the revenue when an advertisement is run. Similarly, in many advertising transactions, it is customary for the rep firm that sold the advertising space to the advertiser to receive a percentage of the revenue when an advertisement is run. An advertising agency typically receives a payment of 15% of the revenue, although this may vary. A rep firm typically receives a payment of 6%, although this may vary. In the integrated system of this invention, the percentages due to each of such parties is reflected in the bill sent to the advertiser. When the advertiser makes the single payment of the invoice presented to them, the electronic payment system of this invention automatically generates appropriate payments to all parties involved in the particular transaction, including if appropriate, but not limited to, the publisher, the advertising agency and the rep firm.

Once the advertising user has completed using the system in step 62, they may log off in step 64.

Providing a proof of publication is an important part of advertising practice. Traditionally, in non-electronic systems, this is done by sending a tearsheet along with the bill. This tearsheet is a physical page containing the advertiser's insertion taken from the actual publication on the day it is printed. Seeing the actual page asures the advertiser that the advertisement was placed on an appropriate page at the required size and produced with appropriate quality. In order to provide a comprehensive and completely electronic solution covering all the process required in advertising transactions in a printed publication, it is necessary to provide an electronic equivalent of the tearsheet. Solutions such as simply sending an electronic copy of the file or of scanning in a page fail to provide such an electronic equivalent, primarily because digital images are so easy to manipulate.

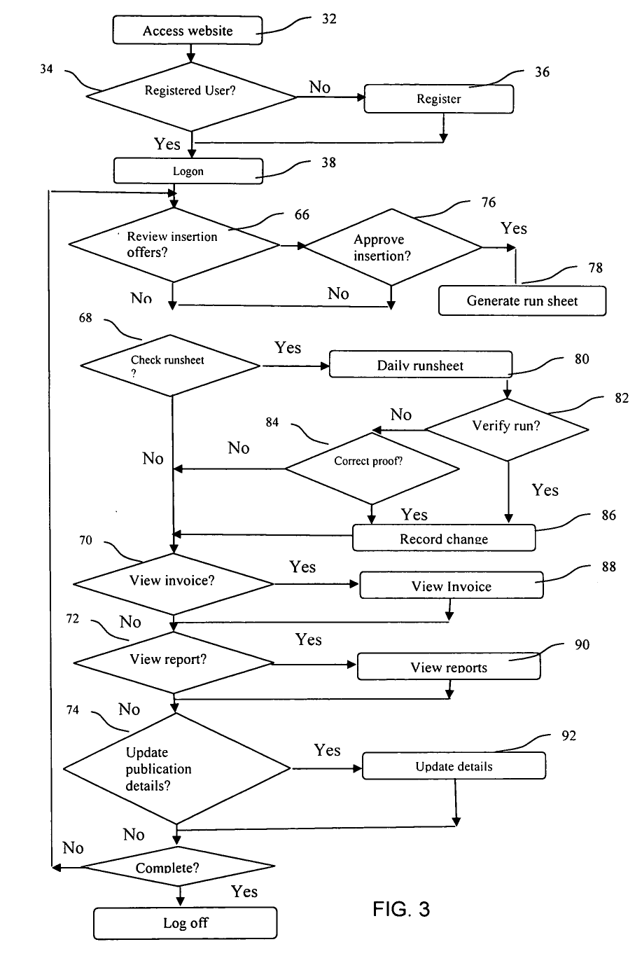

FIG. 3 is a schematic flow chart showing one embodiment of the methods of the present invention as applicable to a publisher. The publishing user accesses the website in step 32 and proceeds to steps 34, 36 and 38 as described above. However, in step 38, the publishing user has an appropriate media code allowing them access to the functions appropriate to a newspaper publisher including, but not limited to the ability to review insertion offers in step 66, check runsheets in step 68, view invoices in step 70, view reports in step 72 and update publication details in step 74.

If the publishing user selects to review insertion offers in step 66, they may be presented with one or more processing pages which allow them to process any offered amounts. In step 76 they may view the offers and elect to approve them or not. In one embodiment of the invention, step 76 allows them to not approve the offer by submitting counter bides (also known as counter offer rates) different from both the offered rates of the advertising user and the standard rates of the publisher. If the publishing user approves the offer, accepting the offered amount for publishing one or more print advertisements in their print publication, they may proceed to step 78 in which a run sheet is generated. The run sheet may be a schedule comprising a list of dates on which to publish the print advertisements of the offer in the publisher's print publication. The run sheet may also include other relevant data such as, but not limited to, details of the advertisement.

If the publisher selects to check runsheets in step 68, they may proceed to step 80 in which they may review the daily runsheets. If the advertisements have run, i.e., the print advertisement has been run in the appropriate printed publications, the publisher may select to verify the run in step 82. In a preferred embodiment the step 82 of verifying the run may include being presented with one or more proof of publication pages which allow the publisher to upload digital proof of publications. In a preferred embodiment, this digital proof of publication may be in the form of a digital tearsheet, i.e. a digital image of a paper tearsheet placed on a fiducial underlay. Details of how to supply such digital tearsheet is described below in greater detail.

On reviewing the runsheet in step 80, the publishing user may also wish to correct a proof in step 84. If a publishing user either corrects a proof in step 84 or verifies a run in step 82, they may proceed to step 86 in which these actions or changes are recorded.

In step 70 the publishing user may to view an invoice by proceeding to step 88 in which one or more web pages are presented with appropriate invoice data.

In step 72, the publishing user may proceed to step 90 and view activity reports. This reports may include, but are not limited to, reports of daily, weekly, monthly activity related to an account, an advertiser, a publication or some portion or combination thereof. These reports, which may be customized by the user making appropriate choices, allow the user to for instance, but not limited to, view the advertisements that ran and which periodicals they were published in along with the rates charged. Additional reports can be created. The system also generates reports for the publisher, including reports which allow the publisher to view which ads are scheduled to run in which of their publications. In a preferred embodiment of the invention, all reports are available to be downloaded in standard formats such as, but not limited to Excel, PDF, Word or Text Files.

In step 74, the publishing user may select to update the publication details by proceeding to step 92. The details up loaded may include, but are not limited to, publication data, circulation data and rates. In a preferred embodiment these are accomplished via a secure web page.

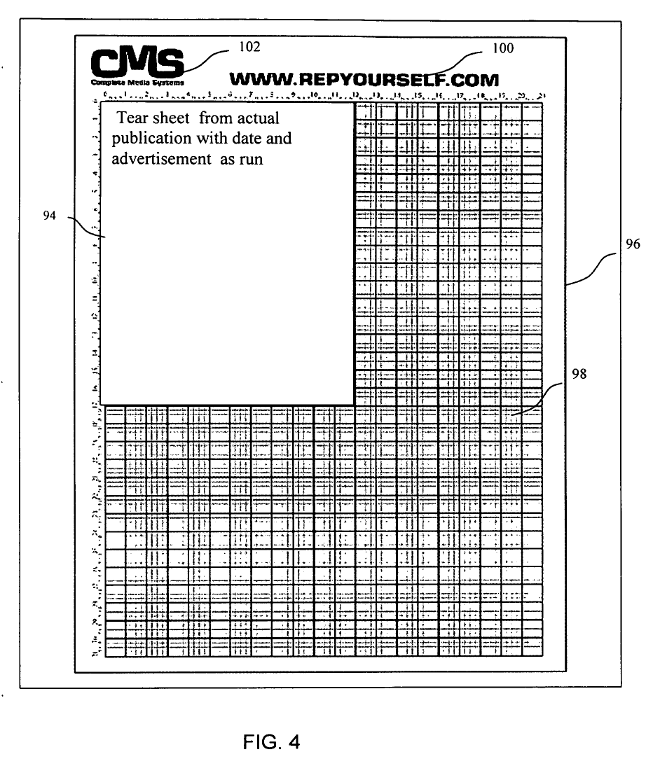

FIG. 4 shows a simple proof of publication that can be digitized and still function satisfactorily as a proof of publication. In the proof of publication shown in FIG. 3, a tearsheet 94 is digitized along with a fiduciary underlay 96. By digitizing a page containing the advertiser's insertion taken from the actual publication on the day it is printed along with a fiducial underlay, the advertiser is able to judge size and quality even from a digitized image. The fiducial underlay may include a board marked with appropriate fiducial markings including, but not limited to, a grid pattern 98, alpha numeric characters 100, including lettering and numbering, and logos 102, or some combination thereof. The alpha numeric characters may be chosen to be representative of advertising text in their choice or range of font size and/or font type. By including known or fiducial markings along with the tearsheet, the advertiser can, by comparison, judge the size and quality of the advertisement in the tearsheet. In one embodiment of the invention, the fiducial markings include specific colored markings to provide a color reference or fiducial. In one embodiment a color fiducial may be a color marking or indicia representative of a printed advertisement. For instance, the color fiducial may be a color image that appears as part of an advertisement that has been printed to the accepted color requirement on the fiducial underlay. A digital color image of the tearsheet with the color advertisement as printed in the print publication alongside a copy of the same of similar color image, pre-printed to the required acceptable quality standards, easily shows any differences, even if the digital image has color distortions. This is because the distortions will be the same in both images and therefore all the advertiser has to look for is differences between the images. If there are no differences, the advertiser can be assured that the of that the absolute color of the printed advertisement is acceptable.

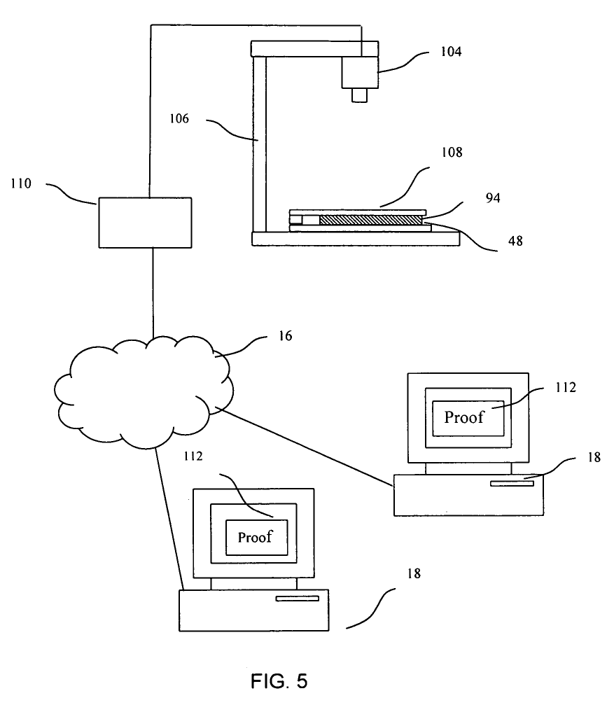

FIG. 5 shows a schematic view of one method of producing and distributing an electronic proof of publication. A suitable digital camera 104 is held in place by a suitable support structure 106 so as to be able to photograph a tearsheet 94 placed on top of a fiducial underlay 98 An optional transparent overlay 108 may be used to hold the tearsheet in place while the photograph is being taken. The digitized image or digital proof of publication is transmitted from the camera to a local server 110. In one embodiment of the invention this transmission may be wireless. From the local server 110, the digital proof of publication may for instance, be linked to a bill and transmitted over a suitable network 16 to a remote computer with an attached viewing monitor 18 where the advertiser may view a copy 112.

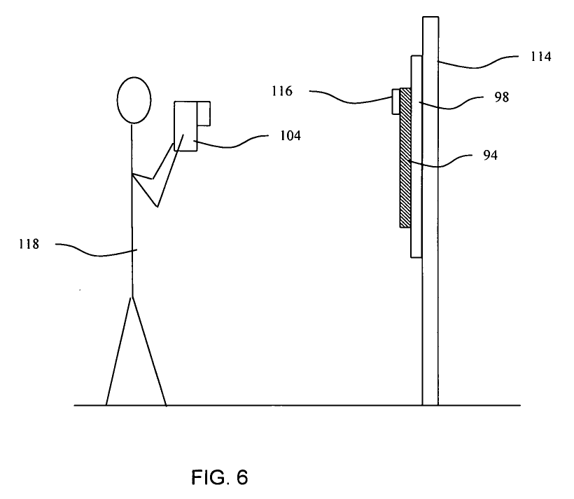

FIG. 6 shows a schematic view of the generation and transmission of a proof of publication by the preferred embodiment of the integrated system of this invention. In this the fiducial underlay 98 is attached to a vertical surface 114 such as, but not limited to a wall, door or window. The tearsheet 94 is placed over the underlay 98 and held in place by holding means 116 which may for instance be, but is not limited to, adhesive tape, thumb-tacks or magnetic material. A digital image is then taken of the tearsheet 94 appropriately aligned over the fiducial underlay 98 by an operator 118 using an appropriate digital camera 104. The image in the digital camera 104 may then be transferred to the server. This transfer may be via a physical medium such as but not limited to, a memory card, a floppy disc or a removable drive. The transfer may alternatively be made by a wired connection or by a suitable wireless transmission including, but not limited to, well-known wi-fi or blue-tooth wireless transmission devices and protocols. Digital camera 104 may also be a cell phone having an appropriate imaging system, in which case the digital proof of publication may be transmitted by cellular network to the electronic transaction website.

Although the proof of publication is shown as being digitized by photography, one skilled in the art will readily appreciate that other methods of digitizing the tearsheet in place on the fiducial underlay may be substituted. The digitizing may be done by for instance, but not limited to, placing the tearsheet on a fiducial underlay and scanning the combination. In an alternate embodiment of the invention, the fiducial underlay may for instance be integrated into the cover of a flatbed scanner.

Although that present invention has been described with reference to discrete embodiments, one of skill in the art will recognize certain insubstantial modifications, minor substitutions, and slight alterations of the apparatus and method described herein, that nonetheless embody the spirit and essence of the described invention.

1. An printed publication, electronic transaction method, comprising the steps of:
submitting, by a first user using a web-site, an offered amount for publishing one or more print advertisements in one or more selected printed publications;
processing, by a second user using said web-site, said offered amount;
publishing, by said second user, said print advertisement in said printed publication;
placing, on said web site by said second user, a digital proof of publication of said publishing;
viewing, by said first user, said digital proof of publication; and
paying, by said first user using said web-site, said offered amount.

2. The method as recited in claim 1, wherein said step of submitting an offered amount further comprises the steps of:
selecting, by said first user, said selected printed publications;
creating an offer using an insertion request form, one or more standard rates, one or more offered rates submitted by said first user, different from said one or more standard rates and one or more run times, said offer including said offered amount and a digital form of said one or more print advertisements; and
submitting said offer.

3. The method as recited in claim 2, wherein said step of selecting further comprises the steps of:
generating a list of suitable printed publications based on a criteria chosen, by said first user, from the group consisting of an advertising type, a classification, a format, a publication frequency and a readership demographic, or a combination thereof; and
selecting, by said first user, said selected printed publications from said list of suitable publications.

4. The method as recited in claim 2, wherein said step of processing further includes the step of negotiating, using said web-site, said negotiation comprising submitting one or more counter-offer rates different from both said offered rates and said standard rates.

5. The method as recited in claim 1, wherein said step of processing further includes the step of generating a run sheet, said run sheet comprising a list of dates of on which to publish said print advertisement in said printed publication.

6. The method recited in claim 1, wherein said placing a digital proof of publication of said publishing, further comprises the steps of:
creating a paper tearsheet, said paper tearsheet comprising said published print advertisement on a printed page of said printed publication;
placing said paper tearsheet on a fiducial underlay, said fiducial underlay comprising scale indicia indicative of an absolute size of said tearsheet; and
creating a digital image of said paper tearsheet on said fiducial underlay.

7. The method recited in claim 6, wherein said fiducial underlay further includes resolution indicia indicative of an absolute resolution of said tearsheet, said resolution indicia comprising one or more alpha-numeric characters having a font size and a font type representative of text in said printed advertisement.

8. The method recited in claim 6, wherein said fiducial underlay further includes color indicia indicative of an absolute color of said tearsheet, said color indicia comprising an image containing one or more colors representative of said printed advertisement.

9. The method recited in claim 1, wherein said paying said offered amount includes automatically making a first electronic payment to said second user, and automatically making a second electronic payment to a provider of said electronic transaction method.

10. An printed publication, electronic transaction system comprising:
a web-site, having:
one or more submission pages capable of receiving, from a first user, an offered amount for publishing one or more print advertisements in one or more selected printed publications;
one or more processing pages capable of allowing a second user to process said offered amount;
one or more proof of publication pages capable of allowing said second user to display a digital proof of publication, whereby said first user may be assured that said second user has caused said print advertisement to be published in said printed publication; and
one or more payment pages capable of allowing said first user to pay said second user said offered amount.

11. The system as recited in claim 10, wherein said one or more submission pages comprise:
one or more publication selection pages capable of allowing said first user to select said selected printed publications; and
one or more offer creation pages capable of displaying an insertion request form and one or more standard rates, said insertion request form being capable of allowing said first user to submit one or more run times and one or more offered rates, different from said one or more standard rates, and one or more digital form of said one or more print advertisements, thereby generating said offer, including said offered amount; and
wherein said one or more submission pages are further capable of submitting said offer.

12. The system as recited in claim 11, wherein one or more publication selection pages are further capable of:
automatically generating a list of suitable printed publications based on a criteria chosen, by said first user, from the group consisting of an advertising type, a classification, a format, a publication frequency and a readership demographic, or a combination thereof; and
allowing said first user to select said selected printed publications from said list of suitable publications.

13. The system as recited in claim 11, wherein said one or more processing pages are further capable of accepting one or more counter-offer rates different from both said offered rates and said standard rates.

14. The system as recited in claim 10, wherein said one or more processing pages is further capable of generating a run sheet, said run sheet comprising a list of dates of on which to publish said print advertisement in said printed publication.

15. The system recited in claim 10, wherein said digital proof of publication comprises a digital image of a paper tearsheet on a fiducial underlay, said paper tearsheet comprising said published print advertisement on a printed page of said printed publication; and said fiducial underlay comprising scale indicia indicative of an absolute size of said tearsheet.

16. The system recited in claim 15, wherein said fiducial underlay further includes resolution indicia indicative of an absolute resolution of said tearsheet, said resolution indicia comprising one or more alpha-numeric characters having a font size and a font type representative of text in said printed advertisement.

17. The system recited in claim 15, wherein said fiducial underlay further includes color indicia indicative of an absolute color of said tearsheet, said color indicia comprising an image containing one or more colors representative of said printed advertisement.

18. The method recited in claim 10, wherein one or more payment pages are further capable of automatically making a first electronic payment to said second user, and automatically making a second electronic payment to a provider of said electronic transaction method.

19. An printed publication, electronic transaction apparatus, comprising:
submission means whereby a first user submits to an web-site an offered amount for publishing one or more print advertisements in one or more selected printed publications;
processing means available from said web-site whereby a second user processes said offered amount;
proof of publication means available from said web-site whereby said second user assures said first user that said print advertisement has been published in said printed publication; and
payment means available from said web-site whereby said first user pays said second user said offered amount.

20. The apparatus recited in claim 19, wherein said proof of publication means comprises means for supplying a digital image of a paper tearsheet on a fiducial underlay, said paper tearsheet comprising said published print advertisement on a printed page of said printed publication; and said fiducial underlay comprising scale indicia indicative of an absolute size of said tearsheet.
